(19) United States
(12) Patent Application Publication
(10) Pub. No.: US 2026/0072648 A1
(43) Pub. Date: Mar. 12, 2026

(54) GENERATIVE AI-BASED TOOL FOR IDENTIFICATION AND RESOLUTION OF LINT ERRORS

(71) Applicant: Microsoft Technology Licensing, LLC, Redmond, WA (US)

(72) Inventors: Sheena GOEL, Austin, TX (US); Luke Tee Xuan KOK, Morrisville, NC (US); Erik William BERG, Portland, OR (US); Raymond Peter RAMIREZ BELTRAN, Portland, OR (US); Thomas David RILEY, Raleigh, NC (US)

(21) Appl. No.: 18/830,343

(22) Filed: Sep. 10, 2024

(51) Int. Cl. G06F 8/30; G06F 11/36

(52) U.S. Cl. CPC G06F 8/30; G06F 11/3604

(57) ABSTRACT

Embodiments of the present disclosure include a software solution for resolving Lint errors in a verification software application. A RAG index can be queried for a RAG entry that is similar to a given Lint error detected in the source code. The RAG entry returned from the query can in turn be utilized in generating a prompt for a Large Language Model (LLM). The LLM receives the prompt and generates a result that contains replacement software code that is subsequently presented to the user as a possible solution to correct the Lint error in the verification software.

### BACKGROUND

The present disclosure relates generally to scalable generative AI-based tool infrastructures and in particular to an application of a scalable generative AI-based tool infrastructure configured to resolve Lint errors.

Verification systems typically involve the creation of software for performing a variety of tests on circuitry during development. Such systems are commonly developed using a Hardware Description language (HDL), such as Verilog. Verilog code, for example, may define the proper behavior of the system such that the design can be tested to confirm proper operation. Prior to physical construction of the digital circuits, the digital system may be represented as one or more software files. This is also written in an HDL language. These digital representations of the digital circuit are then tested to verify that the system performs the features and functions specified by a design specification. This process is commonly referred to as verification.

A verification engineer writes code to develop the verification software. A linter is a software tool used for identifying errors, bugs, and other issues in the verification software itself (i.e., Lint errors). These errors may be unrelated to the intended functionality of the verification software itself but which may introduce unexpected errors. Lint errors cover a wide range of aspects, including syntax, coding style, unsafe constructs, formatting, styling, security vulnerabilities, and portability problems to name a few. Verification engineers spend a considerable amount of time fixing these Lint errors when developing verification software. Thus, there is a need for improved techniques to identify and resolve Lint errors.

### BRIEF DESCRIPTION OF THE DRAWINGS

FIG. 1 illustrates a verification system 102 according to an embodiment.

FIG. 2 illustrates a system for identifying and resolving Lint errors according to some embodiments.

FIG. 3 illustrates an example generative AI-based tool architecture according to an embodiment.

FIG. 4 illustrates an example property generator generative AI-based tool graphical user interface according to an embodiment.

FIG. 5 illustrates an exemplary error log file according to some embodiments.

FIG. 6 illustrates an exemplary graphical user interface according to some embodiments.

FIG. 7 illustrates a workflow for a presenting replacement code generated by a generative AI-based tool according to some embodiments.

FIG. 8 depicts a simplified block diagram of an example computer system, which can be used to implement some of the techniques described in the foregoing disclosure.

### DETAILED DESCRIPTION

Described herein are techniques for developing verification software. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein. While verification software is described here as one example, it is to be understood by those skilled in the art that the scalable generative AI-based tool infrastructure described herein may also be applied to the development of other types of software code.

Embodiments of the disclosure include a tool that leverages generative artificial intelligence to resolve Lint errors, and thereby reducing the time and cost of development. In one embodiment, the present disclosure includes a generative AI-based tool that generates software code that may be used to resolve Lint errors. In certain embodiments, various generative AI-based tools may include some or all of the following. For example, the system may include a generative AI-based tool that may, in response to a given Lint error, generate verification software code to correct the given Lint error. The solution produced by generative AI-based tool are influenced by responses that have been stored in RAG. Or, the solution produced by generative AI-based tool can be saved in RAG to influence future responses & improve overall quality of generated verification code. A generative AI-based tool may generate a graphical user interface to be displayed to a user such as a verification engineer. The graphical user interface may include a plurality of fields where each field may be configured to present one or more of the following: the Lint rule violation, the file in which the violation occurred, the failure lines in the software code file, and the replacement software code generated by the generative AI-based tool. One or more of the fields may be presented simultaneously so that the user may compare the fields. For example, failure lines and the replacement software code may be presented simultaneously so that the user can compare the software code containing the Lint error and the replacement software code that is being recommended to correct the Lint error. The replacement software code may be generated without the user's guidance. However, the user may guide whether to accept the recommended software code to correct the Lint error.

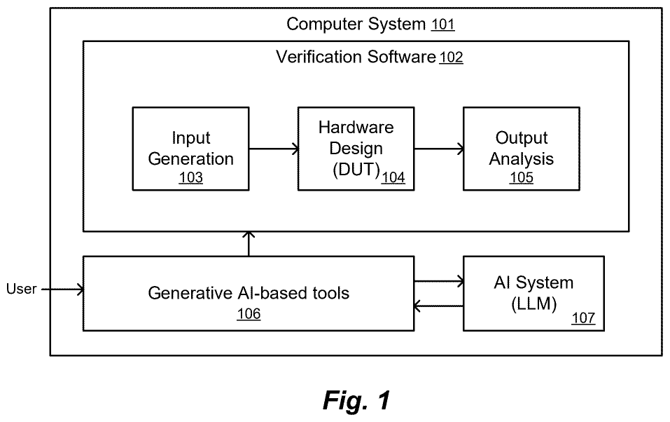

FIG. 1 illustrates a verification system 102 according to an embodiment. Verification software system 102 may execute on a computer system 101, which may include one or more computers, cloud computers, virtual machines or the like that include one or more processors (e.g., central processing units (CPUs) and or customized processors for performing AI functions) and memory (e.g., DRAM, SRAM, non-volatile memory, and the like). Verification software 102 includes a hardware design 104 (aka, a design module or design under test (DUT)), which is a digital representation of a digital circuit being constructed. Verification software 102 includes input generation 103 to generate inputs to design 104 and output analysis 105 to receive outputs generated by design 104 and determine if the outputs conform to the desired functionality and/or specification, for example. In various embodiments described herein, verification software 102 interacts with one or more generative AI-based tools 106 as described in more detail below. In various embodiments, generative AI-based tools 106 may generate customized inputs 110 (aka, prompts) to an artificial intelligence (AI) system 107. AI system may be a large language model (LLM), for example, configured to perform generative AI functions such as publicly available generative AI from GPT-4 by OpenAI®, for example. In other examples, the AI system may be a private LLM, thus providing security and privacy to the data being provided to, and being received from, the LLM. In various embodiments, a user may interact with generative AI-based tool(s) 106 to streamline and automate generation of verification code for verifying a particular design 105, such as input generation 103 and/or output analysis 104, for example. The generative AI-based tool framework includes an index that stores entries containing relevant information for a given programing task or domain. Examples of the relevant information stored in the entries include code snippets, API references, and code examples. The entries may be used as part of the input to the LLM 107 so that the quality of the output of the LLM is improved. While circuit verification is one use case for the generative AI-based tools and the LLM, there are many other applications where a generative AI-based tool in conjunction with an LLM may be able to provide higher quality output in comparison to the LLM alone.

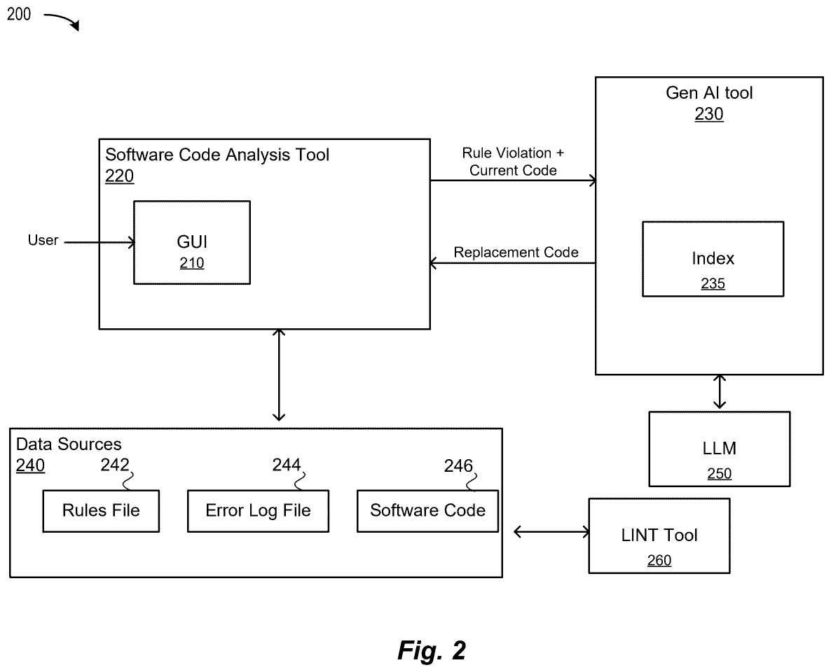

FIG. 2 illustrates a system for identifying and resolving Lint errors according to some embodiments. System 200 may analyze verification software code for violations of Lint rules and then provide recommendations in the form of replacement source code to correct the Lint rule violations. As described herein, a Lint rule violation is also known as a Lint error. A user such as a verification engineer may utilize system 200 to review and correct Lint errors in the verification software code. As shown here, the system 200 includes software code analysis tool 220. Software code analysis tool 200 may be configured to analyze verification software code and interface with the user. Software code analysis tool 200 includes GUI 210 which is configured to generate a graphical user interface which can be presented to the user. In one example, software code analysis tool 220 may be executed on a user's device and GUI 210 may be presented on a display of the user's device to interface with the user. In another example, software code analysis tool 220 may be executed on a server belonging to a service provider as software as a service and GUI 210 may be transmitted to the user's device to be presented on a display of the user device.

Software code analysis tool 220 may be coupled to data sources 240. Data sources 240 stores various data that is accessed during the analysis of the verification software code. Data sources 240 includes rules file 242. Rules file 242 is configured to store Lint rules that the verification software code should abide by. Lint rules may cover a wide range of aspects such as code formatting, syntax errors, naming conventions. The Lint rules are not always related to the functional logic. Instead the Lint rules may help with resolving ambiguity, where different simulators may treat the same line of code differently. Lint rules may help with enforcing coding standards, improve code quality, and improve the maintainability of the software code. Data sources 240 further includes software code 246. Software code 246 is the verification software code of the verification software system described in FIG. 1. Data sources 240 further includes error log file 244. Error log file may store a plurality of entries where each entry describes a Lint error found in software code 246. In one embodiment, Lint tool 260 may be configured to generate error log file 244. For example, Lint tool 260 may receive software code 246 and rules file 242 containing the Lint rules to follow. Lint tool 260 may then apply the Lint rules to software code 246 to determine the line or lines of code that violate a given Lint error. Each Lint rule violation may be stored as an entry in error log file. Once the Lint rules have been applied to software code 246 and all entries have been added to the error log file, Lint tool 260 may transmit the error log file to data sources 240 for storage. In other examples, Lint tool 260 may transmit the error log file directly to software analysis tool 220 along with software code 246.

Software code analysis tool 220 is further coupled to generative AI tool 230. Generative AI tool 230 is configured to generate software code. In one embodiment, the software code generated by generative AI tool 230 may be utilized to correct software code having a Lint error. For example, generative AI tool 230 may receive input data including a segment of the current software code containing the Lint error and the Lint rule that has been violated from software code analysis tool 220. Generative AI tool 230 may process this input data and generate replacement software code. The replacement software code may be a recommended solution to correct the Lint error in the segment of the current software code. A user may review the recommended solution and decide whether to accept or reject the solution. In one embodiment, the replacement software code is presented simultaneously with the current software code on GUI 210 so that a visual comparison of the two can be made by a user and a determination can be made as to whether the user wishes to accept the replacement software code, which may result in the replacement of the current software code with the replacement software code.

Generative AI tool 230 is coupled to Large Language Model (LLM) 250. LLM 250 may be configured to generate output based on a received prompt. In some embodiments, the generated output may be software code that may replace existing software code that has a Lint rule violation. Generative AI tool 230 may generate the input prompt for LLM 250. In one embodiment, generative AI tool 230 may reference index 235 when generating the input prompt. Index 235 contains context entries where each entry contains replacement software code that has been previously approved. The replacement software code may be included in the input prompt as additional context for LLM 250. By providing this additional context, the output generated by LLM 250 may be of higher quality and more accurate. The additional examples provides information of similar solutions of software code that was acceptable to the user in the past which can in turn guide the generation of the current solution. In one example, index 235 stores RAG entries. LLM 250 may generate the replacement software code as output which is then routed to generative AI tool 230, which in turn routes the replacement software code to software code analysis tool 220. As mentioned above, software code analysis tool 220 may simultaneously present the replacement software code and the current software code on GUI 210 so that a user can review the solution and decide whether to accept the solution. If the user accepts the solution, then the replacement software code can replace the current software code in the source code. If the user rejects the solution, there are a few options available to the user. First, the user may wish to regenerate another solution. In this case, the generative AI tool 230 can query LLM 250 a second time. Since the LLM is a stochastic model, applying the same input into LLM 250 may generate a different output. Second, the user may manually update the solution. If the user manually updates the solution and accepts the modified solution, then the modified solution can be stored in the source code. Generative AI tool 230 may update index 235 with solutions that are stored in source code.

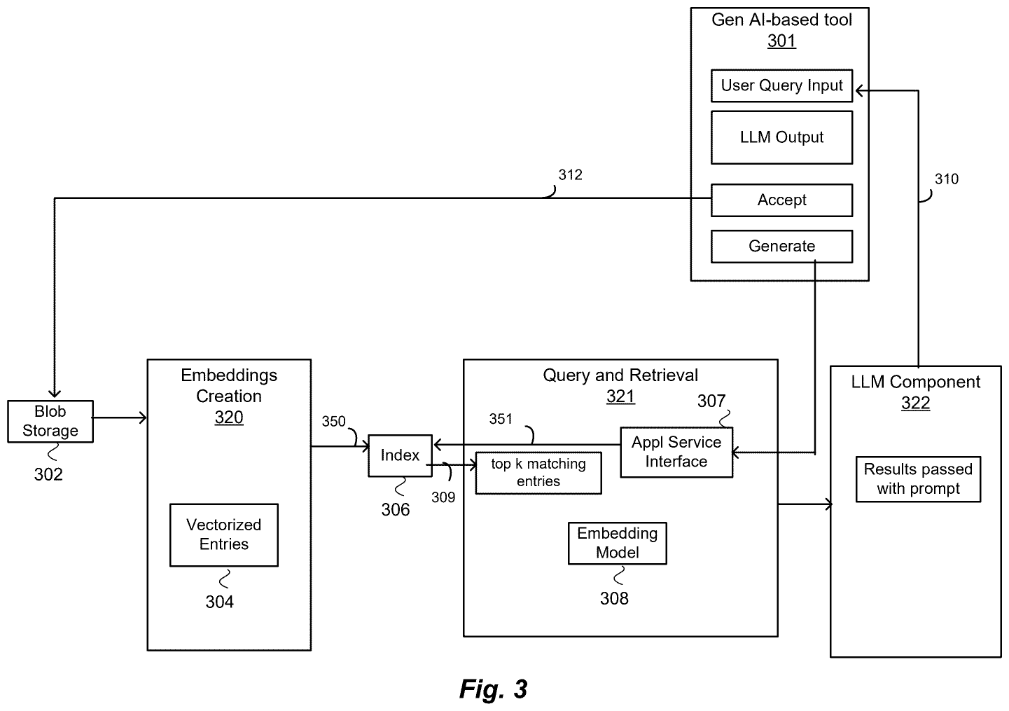

FIG. 3 illustrates an example generative AI-based tool architecture according to an embodiment. In some embodiments the verification techniques described above, as well as other verification techniques, may use the following described generative AI-based tool architecture approach to improve the quality of LLM generated responses. Embodiments of the generative AI-based tool architecture described below may be designed for generating domain specific code syntax that is not well understood by traditional LLMs (e.g., functional coverage, formal verification, RTL assertions, DV Lint, and SKILL syntax). It is to be understood by those skilled in the art that the generative AI-based tool architecture approach described can also be used in many other applications to improve the quality of LLM generated responses, especially in applications where the LLM is not familiar with the code syntax desired in the LLM responses.

Embodiments of the present disclosure may include a retrieval augmented generation (RAG) framework that combines an LLM and an index. As illustrated in FIG. 3, the RAG system includes generative AI-based tool 301, which sends the data that will be used for the RAG index lookup, an embeddings creation component 320, a query and retrieval component 321, and a LLM component 322. Generative AI-based tool 301 may receive a user query input, generate a modified query, receive an LLM output, and allow the user to accept or edit the LLM output. Query and retrieval 321 may include an application service (interface) 307 and an embedding model 308 (e.g. to generate a vectorized query for the index lookup using the LLM model embeddings). A vector is sent to the index 306 at 351. Index lookup occurs and relevant entries are returned from the index in a ranked list at 309 depending on how closely they match the vector for the query. Query and retrieval 321 allows generative AI-based tool 301 to choose the maximum number of entries in the list that in total do not exceed a predefined number of tokens. Here, query and retrieval 321 returns the top k matching entries. The input query can then be supplemented with the retrieved entries. In one embodiment, entries retrieved are added to the query (a.k.a. the modified query) and sent to the LLM 322. At 310, a response from the LLM is sent to the generative AI-based tool where it populates the output window for the user to view. In some examples, this output window is the “Generated code:” window of the generative AI-based tool's GUI. At 312, a user either accepts the response as is or manually edits it before pressing ‘Accept’ button. All the generative AI-based tool fields are saved to the blob storage 302 for this generative AI-based tool. At 304, a vector for the entry is generated and a data object is constructed that contains the vector, date, user, and the query data. This output 350 is then added to the index 306. Advantages to storing the query data and the vector containing the LLM output accepted by the user include that the query-output pair can be used to further improve the quality of index 306 since the index would contain more outputs that were accepted by the user, thereby improving the quality of future queries to index 306.

The LLM may be a neural network that can generate natural language text based on a given input, such as a query or a prompt. An index is a collection of code snippets or documents that contain relevant information for a given programming task or domain, such as API references or code examples.

The index is used as a source of additional context and evidence for the LLM, and to integrate the retrieval and generation processes in a seamless way. In various embodiment, a RAG approach may work as follows.

Given an input query, such as a verification specification or a description, the LLM generates an initial representation of the query. The initial LLM generated query is used to retrieve a set of relevant entries from the index. The retrieval can be done using different methods, such as exact match, keyword search, or semantic similarity, for example. The output is evaluated using a scoring function, which takes into account both the quality of the generation and the relevance of the retrieval. The relevant entries may be ranked according to how well they match the input query. The generative AI-based tool infrastructure may choose the maximum number of entries from this list that can fit in a predefined token window. The scoring function can be learned from data, such as test cases or feedback, or predefined using heuristics or rules. The output with the highest score is selected as the final response.

The retrieved entries from the index are then fed back to the LLM as additional context, along with the original query. The LLM uses this augmented input to generate a refined output, such as a code snippet or a function, that incorporates the information from the index.

Using the currently described approach, the LLM can benefit from the additional information stored in the index, and produce more accurate, informative, and coherent code. The current techniques may further enable the LLM to handle a wider range of programming tasks and domains, without requiring extensive fine-tuning or adaptation. The currently described approach may be applied to various types of LLMs, such as autoregressive or autoencoding models, and various types of indices, such as textual or multimodal. Additionally, the RAG approach described here may help the LLM to follow coding styles, syntax, and conventions that are specific to a programming task or domain, by retrieving and generating code that is consistent with the index. For example, if the index contains code that follows a certain naming convention, indentation style, or documentation format, the LLM can use the retrieved entries as a reference and generate code that matches the same style and format. This can improve the readability, maintainability, and usability of the generated code.

In some embodiments, the index may be carefully curated, updated, and validated by a user for the specific programming task and domain. The generative AI-based tool infrastructure allows users access to the indexed entries affecting the responses to their prompts so that poor responses can be linked to bad index entries and potentially removed.

RAG, on the other hand, does not modify the parameters of the LLM, but rather augments the LLMs input with external knowledge sources. RAG can enhance the capabilities of the LLM without compromising its generality or diversity, and it can leverage unlabeled or weakly labeled data, such as web pages or code repositories, which are more abundant and accessible than labeled data. RAG may be cheaper to deploy and allows the generative AI-based tool infrastructure to leverage individual indices for domain-specific tasks.

In one example implementation, a scalable generative AI-based tool architecture may include a GUI frontend built from a class-based, widgetized code structure. A portion of the GUI comprised of the “Generated code” window and the buttons at the bottom may, in some example embodiments, be standard for generative AI-based tools, and may contain the connections into the RAG infrastructure. The top portion of the GUI may be customizable based on the data provided by the user to build their query.

A default generative AI-based tool GUI has the following features divided into user customizable and default collateral. User customizable fields include:
Description (query) entry: users can type in natural language what they want the LLM to generate as code.
Custom context button: creates popup window where users can provide additional information or constraints for the query, such as struct definitions or variables.
Edit instructions button: creates popup window where users can adjust the default query instructions that are sent to the LLM.

Default components may include:
Generated code section: users can see the output of the LLM in response to the query. The generated code section is editable, so users can modify the code as they wish before accepting it.
Accept button: users confirm that they are satisfied with the text in the generated code section and add it to the blob storage that supplies the entries for the index.
View RAG Entries button: creates popup window where users can [view] the entries from the index that were retrieved during the RAG flow and used as part of the prompt for the generated code.

As mentioned above, an advantageous approach to generative AI may be achieved through a bottoms-up approach where the user deconstructs a problem into the component parts, asks the AI to solve each component and then asks the AI to synthesize the component solutions into a larger solution. To facilitate this, the generative AI-based tool architecture can be used to build a generative AI-based tool of generative AI-based tools. This approach may be leveraged by the Coverage and Formal Verification generative AI-based tools, as examples. For instance, the task of building coverage collateral is staged to use generative AI to build (1) individual covergroups and coverpoints, (2) coverage modules composed of the covergroups and coverpoints, and then (3) bind modules to connect the coverage modules to the design. The cover property, coverage module, and bind module generative AI-based tools each query and contribute to separate indexes that are specific to their syntax requirements. A similar approach may be used in the Formal Verification generative AI-based tool described above, for example. The formal property generative AI-based tool and the coverage property generative AI-based tool may use the same code except that the default instructions are different, and they use separate index data for code generation. The property module and bind module generative AI-based tools may include the same code base and the same index data as the Coverage generative AI-based tool.

The following describes an example process for creating an index from existing collateral. It will explain how to select, format, and upload the collateral, how to specify the metadata and keywords for the index, and how to test and validate the index.

First, an example field structure of the index for the RAG is described. For instance, each document in the index has the following fields:
Query: The natural language prompt that the user gives to the LLM as input. It describes the collateral that the user wants the LLM to generate. For the coverage generative AI-based tool, the description field would have the description of a cover property for a testplan entry. For the formal verification generative AI-based tool, the description would be for an assert property pertaining to an RTL module.
Context: The optional extra information that the user can provide, such as code snippets, signal struct definitions, or background knowledge, to help the LLM generate more accurate and relevant responses.
Instructions: Used to give the LLM a role, how best to complete that role and any other expectations the user has about the style, format, or completeness of the response. There are default instructions for each generative AI-based tool that the user can override or modify with the “Edit instructions” button.
Generated_response: The generated code response that the LLM generates based on the query, context, and instructions.
Accepted_response: The response that the user accepts as correct or satisfactory for their programming task or domain. It can be the same as the generated_response, or it can be modified, corrected, or improved by the user.
Contributor: The employee ID of the person who contributed the entry in the index, used to track the source and quality of the index collateral.
Id: The unique identifier of the document in the index. It can help the user to access, update, or delete the index entry. This entry is generated when the collateral is accepted.

When a new generative AI-based tool is created, the user can choose which of these fields or combinations of these fields are used as part of the index lookup. This gives the user flexibility and control over how the RAG infrastructure searches for the best matching documents in the index. In this example generative AI-based tool architecture, the default fields for index lookup are “query” and “context”. The default fields from each entry that are used as part of the prompt engineering process are “instructions”, “context” “query”, and “accepted_response”. Each generative AI-based tool instance can adjust these as desired by the user.

When a new generative AI-based tool is initially created, the index is empty. To quickly create an index so that users can benefit from the RAG infrastructure, existing collateral from other projects may be directly loaded. The generative AI-based tool creator may create query: response pairs that can be entered into the generative AI-based tool and added into the index with the “Accept” button. In some example embodiments, an index with about 30 entries may boost functional and syntactic accuracy of responses from the LLM by about 90%. The size of the index required to provide measurable benefits to the user may be dependent upon how well user queries map to content stored in the index and how much innate domain syntax knowledge the LLM contains.

After initial seeding of the index, new users will receive better responses from the LLM than they would without the RAG system. When LLM responses do not meet user needs for reasons of style, functionality or syntax, the user can either regenerate the response with the current generative AI-based tool settings, edit the generative AI-based tool fields before regenerating, or manually edit the response.

The generative AI process is inherently stochastic so regenerating may yield a different response that may better meet the user's needs. A user may also choose to edit the fields in the generative AI-based tool to give the LLM more detailed information to help generate a better response.

If the response from the LLM is close but not quite what the user desires, the response can be manually edited in the “Generated Code” window. Pressing the “Accept” button will commit the current generative AI-based tool information to the blob storage for the index to make the query: response information available to future users through the RAG architecture. The tool stores both the “generated_response” and the “accepted_response” in the index. These will converge as more users leverage the generative AI-based tool and commit high quality responses to the index.

### Index Usage and Prompt Engineering

This section will explain how the responses from the RAG infrastructure are used in the prompt engineering process and how the information is passed to the LLM. The prompt engineering process is the method of transforming the user input and the index lookup results into a suitable input for the LLM. The goal is to provide the LLM with enough context and guidance to generate high-quality responses that match the user's expectations and needs. This entire process is managed by the generative AI-based tool and requires no user input.

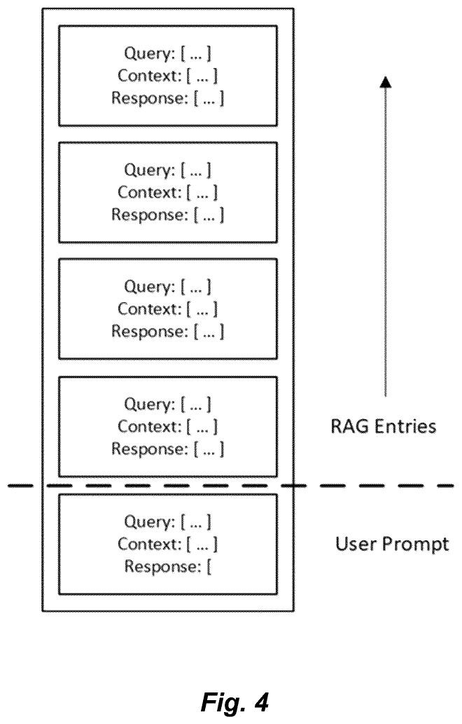

The prompt engineering process consists of the following steps:
1. The user adds the description and any relevant context to the generative AI-based tool and pushes the “Generate” button. The generative AI-based tool constructs the query to the RAG infrastructure based on the fields chosen for that particular generative AI-based tool.
2. The RAG infrastructure performs an index lookup and returns the top k matching index entries from the index. Each index entry contains all the fields previously described in this document, as well as a relevance score indicating how well the index entry matches the user input.
3. The generative AI-based tool infrastructure extracts relevant fields from the index entries and ensures that these selected entries and the rest of the prompt combine to fit within the token window for this LLM model. If the index entries are too large for the allowed token window, the generative AI-based tool will choose the best subset of index entries that fits within the token window. In one embodiment, the best subset of index entries may be selected based on cosine similarity that compares the vectorization of the query with the vectors in the database and returns a sorted list based on the highest value of cosine similarity.
4. The generative AI-based tool constructs a final input for the LLM from the RAG entries and the user's specific query. An example input is shown in FIG. 4.
5. The LLM receives the final input, generates a response and populates the “Generated Code” window. The user can then regenerate or modify the response before accepting it. If the user accepts the response, it is stored in the index with other data scraped from the generative AI-based tool.

In one example implementation, a generative AI-based tool code base is class based and widgetized, allowing users to create new domain-specific syntax generative AI-based tools in minutes that are connected to customized and secure other resources for that generative AI-based tool. New tented blob storage and indices are generated on-demand by new generative AI-based tool deployments.

The generative AI-based tools provide the following benefits to design and verification teams.
1. Remove mundane, tedious, repetitive work to allow engineers to focus on the harder and more interesting engineering problems.
2. Remove the burden of syntax much like compiler removed the burden of machine language to allow people to code in more abstract languages.
3. Give users access to expert knowledge in diverse domains.
   The output of the generative AI-based tools improves continuously as users use them and contribute more information into the supporting data index. A description of the index fields and how to start creating a new one is included.

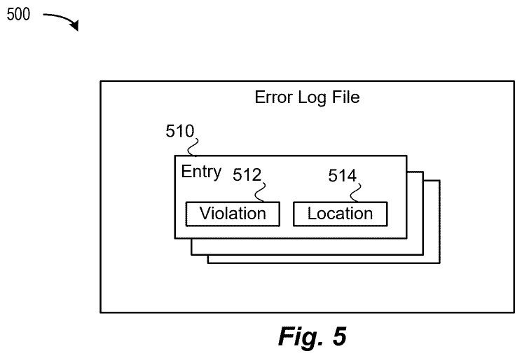

FIG. 5 illustrates an exemplary error log file according to some embodiments. Error lo file 500 may be generated by a lint tool, such as lint tool 260 in FIG. 2. In other embodiments, error log file may be generated by software code analysis tool. Software code analysis tool may apply the Lint rules in a rules file to identify violation of the rules in the software code. Each Lint rule violation detected may be stored as an entry in the error log file. As shown here, error log file 500 includes a plurality of entries. Each entry corresponds to a Lint rule violation found in the software code. In other words, each Lint rule violation found has its own entry in the error log file. Entry 510 includes violation 512 and location 514. Violation 512 specifies a Lint rule that has been violated. Violation 512 may store a unique identifier associated with the Lint rule that has been violated that uniquely identifies the Lint rule from the other Lint rules. Location 514 stores the location in the source code where the violation occurred. In one example, location 514 may store an identifier of the file in which the violation was detected and also store the line number or line numbers in which the Lint error (i.e., violation) occurred. In other embodiments, other data may be stored within each entry to identify the Lint error violation and the software code containing the Lint rule violation. For example, the lines of code containing the Lint rule violation may also be included in the entry.

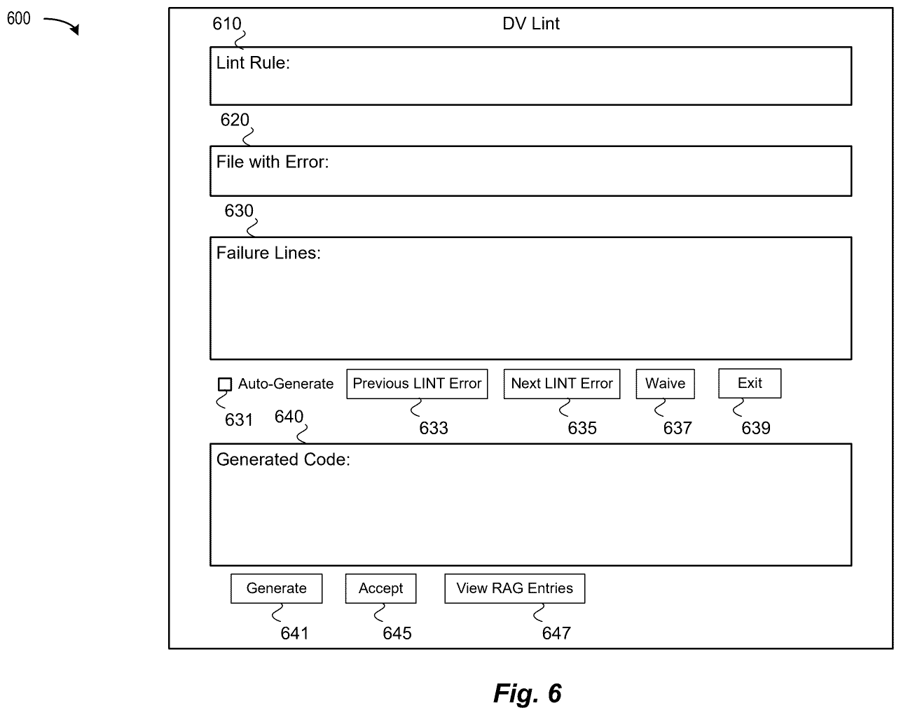

FIG. 6 illustrates an exemplary graphical user interface according to some embodiments. Graphical user interface (GUI) 600 may be generated by software code analysis tool 220 in FIG. 2 and displayed locally or remotely to a user. In other embodiments the fields in GUI 600 may change such that more fields, fewer fields, or different fields are displayed. GUI 600 may be configured to display information that may be useful to an error correcting a Lint error in the software code. This may include displaying lines of current software code that contains a Lint error and also displaying lines of replacement software code that is being recommended to correct the Lint error. As shown, GUI 600 includes rule field 610. Rule field 610 displays the Lint rule that has been violated in the software code. In one embodiment, the Lint rule may be retrieved from an entry in the error log file. GUI 600 further includes file field 620. File field 620 is configured to display information that uniquely identifies the file containing software code that violates the Lint rule displayed in rule field 610. In one embodiment, the file path and/or file name may be displayed in file field 620.

GUI 600 further includes current software code field 630. Current software code field 630 displays the lines of software code that in which the Lint error was detected. These lines of software code are also known as the failure lines. As shown here, current software code field 630 includes the text “Failure Lines:” to indicate that the software code displayed in field 630 contains Lint error. In one embodiment, field 630 may highlight one or more lines of software code as containing the Lint error. However, additional lines of software code above and below the Lint error may also be displayed in field 630 to provide context to the user. In one embodiment, a parameter within software code analysis tool may define the lines of code surrounding the Lint error that should be displayed along with the Lint error. For example, the parameter may specify that three lines of software code above the Lint error should be displayed along with the Lint error. As another example, the parameter may specify that three lines of software code above and below the Lint error should be displayed along with the Lint error. In yet another example, the parameter may specify that the function containing the Lint error should be displayed along with the Lint error.

GUI 600 further includes replacement software code field 640. Replacement software code field 640 is configured to display software code generated by a generative AI-based tool that may correct or resolve the Lint error detected. As shown here, replacement software code field 640 includes the text “Generated code:” to indicate that the software code displayed in the field is generated by the generative AI-based tool. In one embodiment, the software code generated by the generative AI-based tool may be for purposes of correcting the Lint error detected in the block of code displayed in field 630. In other words, the software code displayed in replacement software code field 640 may correspond to the current software code field 630.

GUI 600 further includes a plurality of selectable icons configured to allow a user to interact and provide instructions to the software code analysis tool. Software code analysis tool may execute commands in response to detecting the selection of these icons. Icons 641-649 are associated with the replacement software code field 640. GUI 600 includes generate icon 641. Software code analysis tool may execute commands to generate recommended replacement software code in response to detecting the selection of generate icon 641. Generated replacement source code may be displayed in field 640. The replacement software code may correspond to existing software code displayed in field 630. Selecting the generate icon 641 an additional time indicates that the user would like the generative AI-based tool to regenerate the replacement software code displayed in field 640 by using the same input prompt in the LLM. This may be because the user is dissatisfied with the replacement software code in field 640. Software code analysis tool may execute commands to generate replacement software code a second time in response to detecting the selection of generate icon 641 an additional time. Having the LLM regenerate the replacement software code may result in different replacement software code since the LLM is a stochastic model and therefore applying the same input through the model again may result in a different output. GUI 600 further includes edit icon 645. Software code analysis tool may execute commands to edit the generated replacement code displayed in field 640 in response to detecting the selection of edit icon 645. In some examples, replacement software code generated in response to generate icon 641 may be close to the user's desires. In these instances, the user can manually edit the replacement software code in field 640.

GUI 600 further includes accept icon 645. Software code analysis tool may execute commands to accept the replacement software code displayed in field 640 in response to detecting the selection of accept icon 645. As mentioned above, the replacement software code can be generated by the generative AI-based tool or can be generated by the generative AI-based tool and then manually edited by the user. The commands can include replacing existing software code with the replacement software code. The commands can also include generating a new index entry to be added to the RAG index. The new index entry may include one or more of the following: the Lint rule, the software code that contains a violation to the Lint rule, and the replacement software code accepted by the user. GUI 600 further includes accept View Rag Entries icon 647. Software code analysis tool may generate a pop up window containing the index entry or entries from the RAG index that were included in the input prompt of the LLM when generating the replacement code in response to detecting the selection of View RAG Entries icon 645. Viewing the index entry or entries may provide context in terms of how the replacement code was generated. An index entry may include the following fields: date added, unique identifier, author, the Lint rule, the current software code, and the replacement code. Below is an example of a RAG entry in JSON format:

```
  [
  {
  “query”: “\n<rule id=\”SVTB.1.1.9\“\n>\n</rule>\nID: SVTB.1.1.10\nNAME:
SVTB.1.1.10\nTITLE: Binary operators spacing\nSEVERITY:
ERROR\nDESCRIPTION:\nUse space around binary operators.\n\nExamples:\nint a=b+c; //
not allowed\nint a = b + c; // allowed\nint a = b + c; // allowed iff allowMultipleSpaces is
true\nint a = b\n+ c; // allowed iff allowIndentationOfMultilineOperators is true\n\nCheck
supports pre-waiving.\nCheck supports auto-correcting.\n”,
  “context”: “”
  “accepted_response”: “\n //Code added to show capability of DV Lint Copilot:\n
if((input_signal1 === 1′b1) && (input_signal2 === 0)) begin\n
‘uvm_info(\“EXAMPLE_SEQ\”, $sformatf(\“Actual value in hex : 0x%x\”, (input_signal1 &
input_signal2)), UVM_LOW)\n if(input_signal3 !== 0) begin\n
‘uvm_error(\“EXAMPLE_SEQ\”, $sformatf(\“input_signal3 = %x\”, input_signal3))\n\n”,
  “instructions”: “\nThe following system verilog code violates the specified system
verilog Lint error.\nRewrite the system verilog code so that the Lint error is fixed, code
only.\nAny blank lines that are present in the system verilog code should be preserved.\n The
existing indentation scheme should be preserved.\n”,
  “generated_response”: “systemverilog\n //Code added to show capability of DV Lint
Copilot:\n if((input_signal1 === 1′b1) && (input_signal2 === 0)) begin\n
‘uvm_info(\“EXAMPLE_SEQ\”, $sformatf(\“Actual value in hex : 0x%x\”, (input_signal1 &
input_signal2)), UVM_LOW)\n if(input_signal3 !== 0) begin\n
‘uvm_error(\“EXAMPLE_SEQ\”, $sformatf(\“input_signal3 = %x\”, input_signal3))\n\n”,
  “verilog_code”: “\n\n //Code added to show capability of DV Lint Copilot:\n
if((input_signal1 == 1′b1) && ((input_signal2 == 0))) begin\n
‘uvm_info(\“EXAMPLE_SEQ\”, $sformatf(\“Actual value in hex : 0x%x\”, (input_signal1 &
input_signal2)), UVM_LOW)\n if( input_signal3 != 0) begin\n
‘uvm_error(\“EXAMPLE_SEQ\”, $sformatf(\“input_signal3 = %x\”, input_signal3))”,
  “contributor”: “sheenagoel”,
  “id”: “64435699550”,
  “date”: “2024-08-08”
    }
  ]
```

Icons 631-637 are associated with the current software code field 630. GUI 600 includes auto-generate icon 631. As described above, replacement software code corresponding to the failure lines displayed in field 630 can be generated in response to detecting the selection of generate icon 641 or regenerate icon 643. The process to generate the replacement software code may take some time as the request is processed by the generative AI-based tool and the LLM. The time it takes to generate the replacement software code may also depend on the workload of the system. In order to reduce the period of time where the user is waiting for a response to be generated, the software code analysis tool can transmit multiple queries to the generative AI-based tool in parallel. This way, the generative AI-based tool may generate a number of responses ahead of time so that a quick response is possible. The generation of these responses may be during periods where the workload is lower. In one embodiment, the entries corresponding to the next 5 Lint errors can be transmitted to the generative AI-based tool to generate replacement software code to address the next 5 Lint errors. Each Lint error may include a corresponding replacement software code. The replacement software code may be stored locally on the software code analysis tool. When the user iterates to the next Lint error, the replacement software code corresponding to the next Lint error can be displayed in field 640. Since the replacement software code was previously generated, software code analysis tool is able to, in general, more quickly display the replacement software code in field 640 when compared to generating the replacement software code after software code associated with the Lint error is displayed in field 630. As the Lint errors are processed, entries corresponding to additional Lint errors may be transmitted to the generative AI-based tool to maintain a queue of 5. This may save time the user spends reviewing the replacement software code since the replacement software code can be retrieved and displayed in field 640 without requiring generation through the LLM. In other embodiments, the size of the queue can vary and other techniques may be applied to pre-generate the replacement software code prior to the software code related to the Lint error being displayed in field 630.

GUI 600 further includes Previous Lint Error icon 633. Field 630 may display failure lines corresponding to a current entry in the error log file. Software code analysis tool may iterate to the previous entry in the error log file in response to detecting the selection of Previous Lint Error icon 633. The previous entry may be the entry that appears before the current entry in the error log file. Iterating to a previous entry results in the display of information related to the previous entry. For example, the software code associated with the previous entry, the filename associated with the previous entry, and the Lint rule violated in the previous entry may all be displayed in GUI 600. GUI 600 further includes Next Lint Error icon 635. Field 630 may display failure lines corresponding to a current entry in the error log file. Software code analysis tool may iterate to the next entry in the error log file in response to detecting the selection of Next Lint Error icon 635. Through the use of icons 633 and 635, a user can iterate through the different entries in the error log file.

GUI 600 further includes Waive icon 637. In some instances, a user may review the software code displayed in field 630 and decide that the Lint error detected is either not an error or is a minor error that does not need correction. Software code analysis tool may flag or tag the entry as one which does not need to be corrected in response to detecting the selection of Waive icon 637. This flag or tag may be stored within the software code analysis tool or alternatively as part of the error log file. In one embodiment, an entry that has been waived may be deleted from the error log file. GUI 600 further includes exit icon 639. Software code analysis tool may exit the software application in response to detecting the selection of exit icon 639.

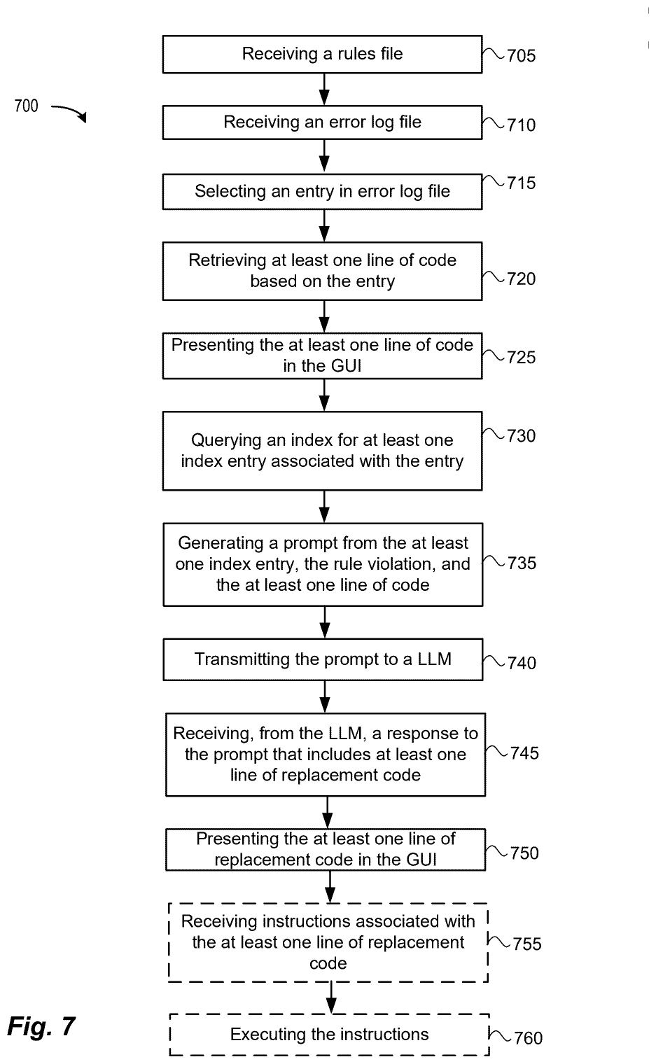

FIG. 7 illustrates a workflow for a presenting replacement code generated by a generative AI-based tool according to some embodiments. Workflow 700 may be implemented in computer readable code and executed by a processor within a computer system. In one embodiment, workflow 700 can reside in software code analysis tool 220 and generative AI-based tool 230 of FIG. 2. Flowchart 700 begins by receiving a rules file at 705. The rules file contains a plurality of rules to be applied to software code associated with a software application, such as a verification application. In one example, the plurality of rules are Lint rules.

Workflow 700 then continues receiving an error log file at 710. Error log file contains a plurality of entries, wherein each entry includes a rule violation of one of the rules stored in the rules file and also a location in the software code where the rule violation has been detected. The location can be one or more lines of code in one of the files containing the software code. Workflow 700 continues by selecting an entry in the error log file at 715. The entry may be the first entry in the error log file or may be a different entry selected by the user. For example, the user may iterate to different entries in the error log file by selecting icon 633 or icon 635 in GUI 600 of FIG. 6. Workflow 700 continues by retrieving at least one line of code based on the entry at 720. In one embodiment, the location stored in the entry identifies one or more lines of software code and the one or more lines of software code can be retrieved based on the location stored in the entry. In some embodiments, additional lines of code may be retrieved to provide context. The lines of code surrounding the identified lines of code may also be retrieved. In one embodiment, an additional 3 lines of code above and below the identified lines of code are retrieved to provide additional context. In another embodiment, the entire function in which the identified lines of code is retrieved to provide additional context.

Workflow 700 may then continue by presenting the at least one line of software code in the GUI at 725. The one or more lines of code can be presented in a field of the GUI, such as field 630 in FIG. 6. Workflow 700 then continues by querying an index for at least one index entry associated with the entry at 730. In one embodiment, the query is for an index entry associated with the rule violation that corresponds with the entry.

Workflow 700 then continues by generating a prompt from the at least one index entry, the rule violation corresponding to the entry, and the at least one line of code at 735. In one embodiment, the prompt may include the at least one line of code that is identified from the location of the entry. In another embodiment, the prompt may include the at least one line of code that is identified in the entry plus any additional lines of code that were retrieved to provide additional context. The prompt is then transmitted to a LLM at 740. Workflow 700 then continues by receiving, from the LLM a response to the prompt that includes at least one line of replacement code at 745. Workflow 700 may then continue by presenting the at least one line of replacement code in the GUI at 750. In some embodiments, the at least one line of replacement code is presented simultaneously as the at least one line of code so that a user can compare the two and decide whether to replace the at least one line of code with the replacement code. Optionally, workflow 700 may continue by receiving instructions associated with the replacement code at 755 and execute the instructions at 760. Some exemplary instructions include accepting the replacement code, regenerating the replacement code, rejecting the replacement code, or modifying the replacement code. Once processing related to an entry in the error log file is completed, workflow 700 may continue by processing other entries in the error log file. The next entry selected may be dependent on the instructions received from the use via the GUI. For example, the next entry may be selected if it is detected that icon 635 of GUI 600 in FIG. 6 is selected.

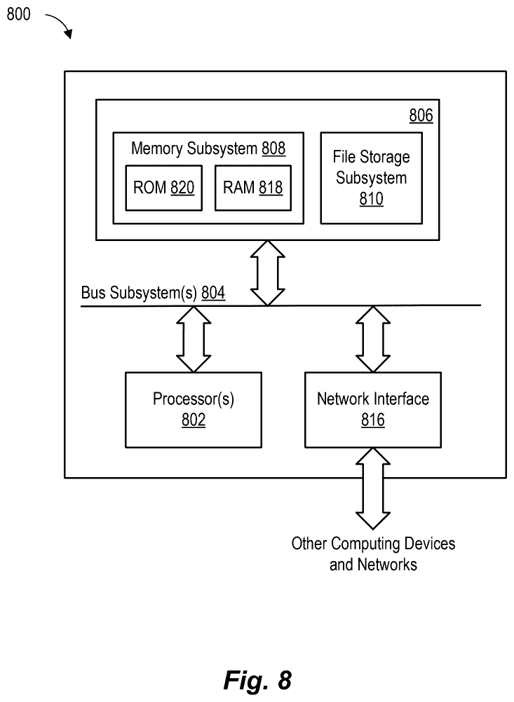

FIG. 8 depicts a simplified block diagram of an example computer system, which can be used to implement some of the techniques described in the foregoing disclosure. As shown in FIG. 8, system 800 includes one or more processors 802 that communicate with several devices via one or more bus subsystems 804. These devices may include a storage subsystem 806 (e.g., comprising a memory subsystem 808 and a file storage subsystem 810) and a network interface subsystem 816. Some systems may further include user interface input devices and/or user interface output devices (not shown).

Bus subsystem 804 can provide a mechanism for letting the various components and subsystems of system 800 communicate with each other as intended. Although bus subsystem 804 is shown schematically as a single bus, alternative embodiments of the bus subsystem can utilize multiple buses.

Network interface subsystem 816 can serve as an interface for communicating data between system 800 and other computer systems or networks. Embodiments of network interface subsystem 816 can include, e.g., Ethernet, a Wi-Fi and/or cellular adapter, a modem (telephone, satellite, cable, etc.), and/or the like.

Storage subsystem 806 includes a memory subsystem 808 and a file/disk storage subsystem 810. Subsystems 808 and 810 as well as other memories described herein are examples of non-transitory computer-readable storage media that can store executable program code and/or data that provide the functionality of embodiments of the present disclosure.

Memory subsystem 808 comprise one or more memories including a main random access memory (RAM) 818 for storage of instructions and data during program execution and a read-only memory (ROM) 820 in which fixed instructions are stored. File storage subsystem 810 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 800 is illustrative and many other configurations having more or fewer components than system 800 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. Embodiments of the present disclosure may include systems, circuits, and methods.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

In some embodiments, a method, comprising receiving a rules file containing a plurality of rules to be applied to software code of an application, receiving an error log file containing a plurality of entries, each entry including a rule violation of one of the plurality of rules and a location in the software code where the rule violation was detected and for each entry of the plurality of entries, processing the entry, wherein processing the entry includes: retrieving at least one line of code from the software code based on the location corresponding to the entry, presenting, in a graphical user interface, the at least one line of code; querying an index for at least one index entry associated with the rule violation corresponding to the entry, generating a prompt from the at least one index entry, the rule violation, and the at least one line of code, first transmitting the prompt to a Large Language Model (LLM), receiving, from the LLM, a response to the prompt, wherein the response includes at least one line of replacement code to replace the at least one line of code, and presenting, in the graphical user interface, the at least one line of replacement code.

In one embodiment, processing the entry further includes: determining the at least one line of replacement code is accepted and replacing, in the software code, the at least one line of code with the at least one line of replacement code.

In one embodiment, wherein processing the entry further includes updating the index to include a new index entry, the index entry containing the at least one line of replacement code and the rule violation.

In one embodiment, wherein processing the entry further includes: receiving an edit to the at least one line of replacement code and replacing, in the software code, the at least one line of code with the at least one line of edited replacement code.

In one embodiment, wherein processing the entry further includes: receiving a request to regenerate the at least one line of replacement code, second transmitting the prompt to the LLM, receiving, from the LLM, a second response to the prompt, wherein the second response includes alternative replacement code to replace the at least one line of code, and presenting the alternative replacement code in the graphical user interface.

In one embodiment, the graphical user interface includes a first window configured to present the rule violation, a second window configured to present the at least one line of code, and a third window configured to present the at least one line of replacement code, wherein the rule violation, the at least one line of code, and the at least one line of replacement code are presented simultaneously.

In one embodiment, retrieving the at least one line of code from the software code based on the location corresponding to the entry includes identifying the function corresponding to the location in the software code where the rule violation has occurred and retrieving the function.

In one embodiment, the software code is configured for silicon design verification and the plurality of rules are Lint rules.

In some embodiments, a system, comprising one or more processors, a non-transitory computer-readable medium storing a program executable by the one or more processors, the program comprising sets of instructions for: receiving a rules file containing a plurality of rules to be applied to software code of an application, receiving an error log file containing a plurality of entries, each entry including a rule violation of one of the plurality of rules and a location in the software code where the rule violation was detected and for each entry of the plurality of entries, processing the entry, wherein processing the entry includes: retrieving at least one line of code from the software code based on the location corresponding to the entry, presenting, in a graphical user interface, the at least one line of code; querying an index for at least one index entry associated with the rule violation corresponding to the entry, generating a prompt from the at least one index entry, the rule violation, and the at least one line of code, first transmitting the prompt to a Large Language Model (LLM), receiving, from the LLM, a response to the prompt, wherein the response includes at least one line of replacement code to replace the at least one line of code, and presenting, in the graphical user interface, the at least one line of replacement code.

In some embodiments, a non-transitory computer-readable medium stores a program executable by one or more processors, the program comprises sets of instructions for: comprising receiving a rules file containing a plurality of rules to be applied to software code of an application, receiving an error log file containing a plurality of entries, each entry including a rule violation of one of the plurality of rules and a location in the software code where the rule violation was detected and for each entry of the plurality of entries, processing the entry, wherein processing the entry includes: retrieving at least one line of code from the software code based on the location corresponding to the entry, presenting, in a graphical user interface, the at least one line of code; querying an index for at least one index entry associated with the rule violation corresponding to the entry, generating a prompt from the at least one index entry, the rule violation, and the at least one line of code, first transmitting the prompt to a Large Language Model (LLM), receiving, from the LLM, a response to the prompt, wherein the response includes at least one line of replacement code to replace the at least one line of code, and presenting, in the graphical user interface, the at least one line of replacement code.

What is claimed is:

1. A method, comprising:
receiving a rules file containing a plurality of rules to be applied to software code of an application;
receiving an error log file containing a plurality of entries, each entry including a rule violation of one of the plurality of rules and a location in the software code where the rule violation was detected; and
for each entry of the plurality of entries, processing the entry, wherein processing the entry includes:
retrieving at least one line of code from the software code based on the location corresponding to the entry;
presenting, in a graphical user interface, the at least one line of code;
querying an index for at least one index entry associated with the rule violation corresponding to the entry;
generating a prompt from the at least one index entry, the rule violation, and the at least one line of code;
first transmitting the prompt to a Large Language Model (LLM);
receiving, from the LLM, a response to the prompt, wherein the response includes at least one line of replacement code to replace the at least one line of code; and
presenting, in the graphical user interface, the at least one line of replacement code.

2. The method of claim 1, wherein processing the entry further includes:
determining the at least one line of replacement code is accepted; and
replacing, in the software code, the at least one line of code with the at least one line of replacement code.

3. The method of claim 2, wherein processing the entry further includes updating the index to include a new index entry, the index entry containing the at least one line of replacement code and the rule violation.

4. The method of claim 1, wherein processing the entry further includes:
receiving an edit to the at least one line of replacement code; and
replacing, in the software code, the at least one line of code with the at least one line of edited replacement code.

5. The method of claim 1, wherein processing the entry further includes:
receiving a request to regenerate the at least one line of replacement code;
second transmitting the prompt to the LLM;
receiving, from the LLM, a second response to the prompt, wherein the second response includes alternative replacement code to replace the at least one line of code; and
presenting the alternative replacement code in the graphical user interface.

6. The method of claim 1, wherein the graphical user interface includes a first window configured to present the rule violation, a second window configured to present the at least one line of code, and a third window configured to present the at least one line of replacement code, wherein the rule violation, the at least one line of code, and the at least one line of replacement code are presented simultaneously.

7. The method of claim 1, wherein retrieving the at least one line of code from the software code based on the location corresponding to the entry includes identifying the function corresponding to the location in the software code where the rule violation has occurred and retrieving the function.

8. The method of claim 1, wherein the software code is configured for silicon design verification and the plurality of rules are Lint rules.

9. A system comprising:
one or more processors;
a non-transitory computer-readable medium storing a program executable by the one or more processors, the program comprising sets of instructions for:
receiving a rules file containing a plurality of rules to be applied to software code of an application;
receiving an error log file containing a plurality of entries, each entry including a rule violation of one of the plurality of rules and a location in the software code where the rule violation was detected; and
for each entry of the plurality of entries, processing the entry, wherein processing the entry includes:
retrieving at least one line of code from the software code based on the location corresponding to the entry;
presenting, in a graphical user interface, the at least one line of code;
querying an index for at least one index entry associated with the rule violation corresponding to the entry;
generating a prompt from the at least one index entry, the rule violation, and the at least one line of code;
first transmitting the prompt to a Large Language Model (LLM);
receiving, from the LLM, a response to the prompt, wherein the response includes at least one line of replacement code to replace the at least one line of code; and
presenting, in the graphical user interface, the at least one line of replacement code.

10. The system of claim 9, wherein processing the entry further includes:
determining the at least one line of replacement code is accepted; and
replacing, in the software code, the at least one line of code with the at least one line of replacement code.

11. The system of claim 10, wherein processing the entry further includes updating the index to include a new index entry, the index entry containing the at least one line of replacement code and the rule violation.

12. The system of claim 9, wherein processing the entry further includes:
receiving an edit to the at least one line of replacement code; and
replacing, in the software code, the at least one line of code with the at least one line of edited replacement code.

13. The system of claim 9, wherein processing the entry further includes:
receiving a request to regenerate the at least one line of replacement code;
second transmitting the prompt to the LLM;
receiving, from the LLM, a second response to the prompt, wherein the second response includes alternative replacement code to replace the at least one line of code; and
presenting the alternative replacement code in the graphical user interface.

14. The system of claim 9, wherein the graphical user interface includes a first window configured to present the rule violation, a second window configured to present the at least one line of code, and a third window configured to present the at least one line of replacement code, wherein the rule violation, the at least one line of code, and the at least one line of replacement code are presented simultaneously.

15. A non-transitory computer-readable medium storing a program executable by one or more processors, the program comprising sets of instructions for:
receiving a rules file containing a plurality of rules to be applied to software code of an application;
receiving an error log file containing a plurality of entries, each entry including a rule violation of one of the plurality of rules and a location in the software code where the rule violation was detected; and
for each entry of the plurality of entries, processing the entry, wherein processing the entry includes:
retrieving at least one line of code from the software code based on the location corresponding to the entry;
presenting, in a graphical user interface, the at least one line of code;
querying an index for at least one index entry associated with the rule violation corresponding to the entry;
generating a prompt from the at least one index entry, the rule violation, and the at least one line of code;
first transmitting the prompt to a Large Language Model (LLM);
receiving, from the LLM, a response to the prompt, wherein the response includes at least one line of replacement code to replace the at least one line of code; and
presenting, in the graphical user interface, the at least one line of replacement code.

16. The non-transitory computer-readable medium of claim 15, wherein processing the entry further includes:
determining the at least one line of replacement code is accepted; and
replacing, in the software code, the at least one line of code with the at least one line of replacement code.

17. The non-transitory computer-readable medium of claim 16, wherein processing the entry further includes updating the index to include a new index entry, the index entry containing the at least one line of replacement code and the rule violation.

18. The non-transitory computer-readable medium of claim 15, wherein processing the entry further includes:
receiving an edit to the at least one line of replacement code; and
replacing, in the software code, the at least one line of code with the at least one line of edited replacement code.

19. The non-transitory computer-readable medium of claim 15, wherein processing the entry further includes:
receiving a request to regenerate the at least one line of replacement code;
second transmitting the prompt to the LLM;
receiving, from the LLM, a second response to the prompt, wherein the second response includes alternative replacement code to replace the at least one line of code; and
presenting the alternative replacement code in the graphical user interface.

20. The non-transitory computer-readable medium of claim 15, wherein the graphical user interface includes a first window configured to present the rule violation, a second window configured to present the at least one line of code, and a third window configured to present the at least one line of replacement code, wherein the rule violation, the at least one line of code, and the at least one line of replacement code are presented simultaneously.
